(19) United States
(12) Patent Application Publication
(10) Pub. No.: US 2011/0102315 A1
(43) Pub. Date: May 5, 2011

(54) REMOTE CONTROL POINTING TECHNOLOGY

(75) Inventors: Maurice Herman Johan Draaijer, Ittervoort (NL); Teunis Jan Ikkink, Geldrop (NL); Hendrik De Koning, Well Ammerzoden (NL)

(73) Assignee: Koninklijke Philips Electronics N.V.

(21) Appl. No.: 12/995,491

(22) PCT Filed: Jun. 4, 2009
(86) PCT No.: PCT/IB09/52359

§ 371 Date: Dec. 1, 2010

(30) Foreign Application Priority Data
Jun. 19, 2008 (EP) 08104469.5

(51) Int. Cl. G09G 5/00

(52) U.S. Cl. 345/156

(57) ABSTRACT

A pointing device (10) is disclosed comprising a light emitter (65) for emitting a plurality of light beams (100) in mutually different controlled directions. The light beams are individually identifiable. The receiving apparatus that is used with this pointing device comprises a light detector for detecting one or more of the plurality of light beams emitted by the pointing device. It determines which of the plurality of individually identifiable light beams are detected. Based thereon the orientation of the pointing device with respect to a target surface may be determined.

### BACKGROUND OF THE INVENTION

1. Technical Field

The present invention relates to remote control pointing technology in general and to a pointing device in particular.

The present invention also relates to a receiving apparatus for detecting light emitted by a pointing device.

2. Description of Related Art

For easy interaction between a user and interactive content point-and-click operations, typically using a computer mouse, are very common and accepted. Usually, these operations are performed close to the screen and require a flat surface or a device, which is either hard to use or expensive.

On the other hand, for lean-back and relax applications, e.g. watching video and listening to music, the remote control (RC) is commonly used. It can also be observed that the number of RC buttons is growing rapidly due to the growing complexity of the applications it controls. This has led to discontent and confusion on the part of the users on which buttons to press for a specific application.

The current problem is being compounded by the convergence of the traditional lean-back applications with the PC applications with the internet being the backend supporting infrastructure. A dilemma arises with the convergence as both the lean back and PC world have different interaction means.

In order to deal with this problem remote control pointing technology has been developed. An example thereof is disclosed in the patent application US 2006/0267935 A1. This document discloses an input device providing users with a pointing capability that includes a sender portion and a receiver portion. The sender portion is adapted to be manipulated by a user to specify a target point within a target area. The sender portion projects a light beam including a pattern on to the target area. A receiver portion includes sensor units located in the target area. At least some of the sensor units receive a portion of the light beam regardless of the location of the target point within the target area. A processing unit in the receiver portion analyzes the portions of the light beam received by the sensor units to determine an attribute of the target point. The attribute can be the location or relative motion of the target point. The receiver portion may be integrated with a display device.

The disclosed input device has the drawback that its receiver portion is complex, because it comprises a plurality of sensor units distributed over the target area.

It is an object of the invention to provide a pointing device that may be used together with a relatively simple receiving apparatus. It is a further object of the invention to provide a receiving apparatus to be used with the pointing device.

### SUMMARY OF THE INVENTION

Thereto, according to an aspect of the invention a pointing device according to independent claim 1 and a receiving apparatus according to independent claim 9 are provided. Favourable embodiments are defined in dependent claims 2-8 and 10-15.

According to an aspect of the invention a pointing device is provided comprising a light emitter for emitting a plurality of light beams in mutually different controlled directions. The light beams are individually identifiable. As a result thereof, the receiving apparatus that is used with this pointing device may have only a single light detector (sensor) for detecting one or more of the plurality of light beams emitted by the pointing device. Under normal circumstances the light detector will detect only one or a few of the light beams that are emitted by the pointing device. A processor in the receiving apparatus determines which of the plurality of individually identifiable light beams are detected. The light beams that are detected give an indication of the orientation (pointing direction) of the pointing device with respect to a target surface.

The processor of the receiving apparatus may determine the pointing direction of the pointing device based on the determined light beam or light beams and on information about the direction of the determined light beam or light beams.

Furthermore, the light detector may detect the light intensity of the detected light beam or light beams. Based on the detected light intensities the processor may determine which of the detected light beams are taken into account for determining the direction of the pointer. For example, only light beams with a detected light intensity above a threshold or only the light beam with the highest detected light intensity may be used for determining the pointing direction.

The receiving apparatus may be part of an appliance such as a consumer electronics apparatus, a household device, a lighting system, etc. The pointing device may be used to operate the appliance.

According to an embodiment of the invention, the pointing device further comprises a controller for controlling the light emitter to emit only a subset of the plurality of light beams at a time. The subset varies as a function of time. As a result the number of light beams that may be detected at the same time by the receiving apparatus is limited, thereby improving the reliability of the determination of the detected light beams.

The light emitter may emit the plurality of light beams, sequentially, i.e. one-by-one, resulting in an optimal reliability of the determination of the detected light beams.

However, the subsets of light beams emitted at a time may also consist of more than one light beam, which reduces the time that it takes to emit all light beams once.

According to a further embodiment of the invention, the light emitter comprises a plurality of light sources emitting light beams in mutually different directions. The light sources are for example laser pointers. Due to the relatively narrow light beams generated by the laser beams, the pointing direction of the pointing device may be accurately determined.

According to an alternative embodiment, the light emitter comprises a light source for generating light and a segmented shutter. The segments of the shutter are transparent to the light in a first mode and block or attenuate the light in a second mode. The controller of the pointing device controls the modes of each of the segments and thereby the emission of the plurality of light beams. The use of a segmented shutter for the generation of the light beams is cost effective and easily implementable.

According to a still further embodiment of the invention, the light emitter comprises a modulator for modulating information on the emitted light indicative of the light beam or light beams being emitted. This is an efficient way to provide the receiving apparatus with the information that is necessary for determining which of the plurality of individually identifiable, emitted light beams of the pointing device are detected. The receiving apparatus should comprise a demodulator for demodulating the information modulated on the emitted light.

According to an alternative embodiment, the light emitter emits a synchronization signal. The synchronization signal for example consists of a concurrent emission of all light beams during a short time. Subsequently, the light emitter varies the subset of the plurality of light beams being emitted as a function of time in a predetermined way. The processor of the receiving apparatus determines that the synchronization signal of the pointing device is received. It then determines which of the individually identifiable light beam or light beams are detected based on information regarding the predetermined variations to the subsets of the plurality of light beams being emitted by the pointing device. This information is for example stored in the receiving apparatus at the time of manufacturing or in a set-up procedure when the pointing device and the receiving apparatus are used for the first time. According to this embodiment it is avoided that the information must be modulated on the emitted light.

According to yet a further embodiment, the light emitter is adapted for emitting at least some of the plurality of light beams with mutually different light polarizations. Thereto, the light emitter may comprise a plurality of polarization filters with mutually different polarizations. The light detector of the receiving apparatus may comprise a light polarization filter. This enables the receiving apparatus to determine the roll of the pointing device, i.e. the rotation of the pointing device along its longitudinal axis by comparing the detected light intensities of the light beams with mutually different polarizations. It has been determined that users most of the time do not hold the pointing device completely straight but with a roll angle of 10 to 20 degrees. If this roll angle is not taken into account, the determined pointing direction may be not so accurate. According to the embodiment, the roll may be taken into account for determining the pointing direction, thereby increasing the accuracy thereof. Alternatively, the roll of the pointing device may be used as an additional parameter for operating the appliance.

These and other aspects of the invention will be apparent from and elucidated with reference to the embodiments described hereinafter.

### BRIEF DESCRIPTION OF THE DRAWINGS

The invention will be better understood and its numerous objects and advantages will become more apparent to those skilled in the art by reference to the following drawings, in conjunction with the accompanying specification, in which:

FIG. 1 shows a schematic drawing of a pointing system.

FIG. 2 shows a block diagram of a pointing device according to an embodiment of the present invention.

FIG. 3 shows a block diagram of a receiving apparatus according to an embodiment of the present invention.

FIG. 4 shows a technical detail drawing of a pointing system according to an embodiment of the present invention.

Throughout the figures like reference numerals refer to like elements.

### DETAILED DESCRIPTION OF THE PRESENT INVENTION

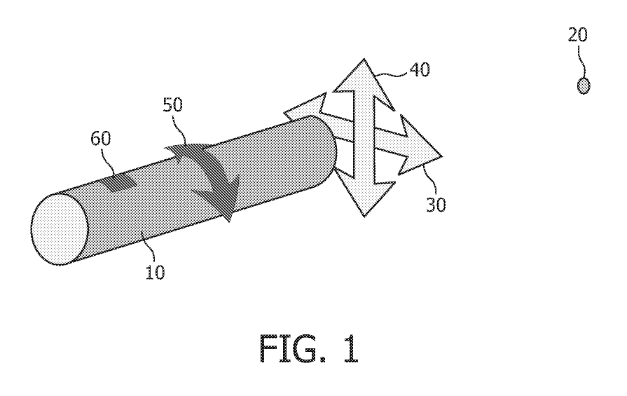

A schematic drawing of a pointing system is shown in FIG. 1. It comprises a pointing device 10 and a receiving apparatus 20. The pointing device is capable of emitting light in such a way that the receiving apparatus 20 can derive the horizontal orientation 30, vertical orientation 40 and the roll 50 of the pointing device, i.e. the orientation around the longitudinal axis thereof. Optionally, the pointing device comprises one or more button(s) 60, which can be used to “select” an appliance to be operated. Examples of appliances that may be operated with a pointing device are a lighting system, an audio device, a television, a game console, a household appliance, etc.

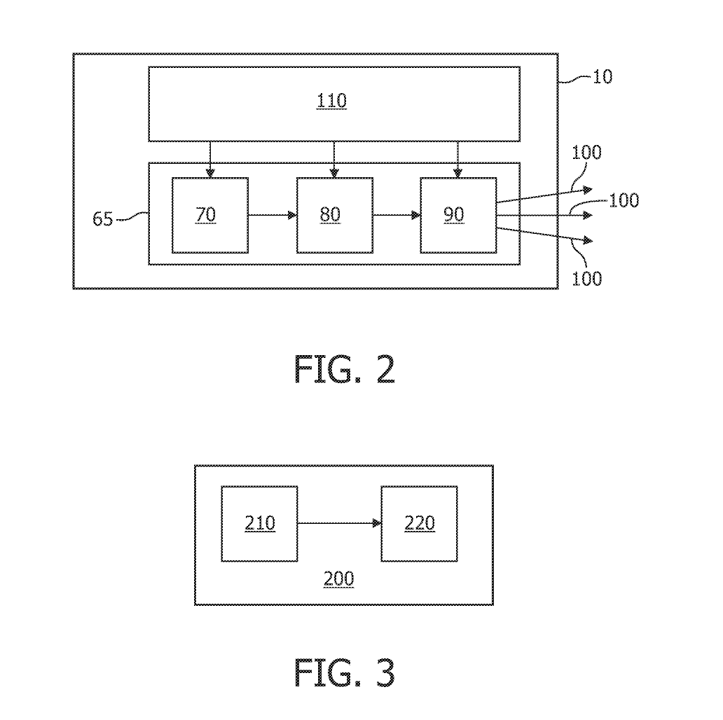

FIG. 2 shows a functional block diagram of the pointing device 10 according to an embodiment of the invention. It comprises a light emitter 65, which comprises a light source 70 for generating light, a modulator 80 for modulating the light generated by the light source with information and a segment shutter 90. The segment shutter 90 blocks a part of the light emitted by the light source and is transparent for another part thereof, as will be described in more detail herein after. As a result, a plurality of light beams 100 is generated in different directions. The pointing device 10 comprises a controller 110 for controlling the light source 70, light modulator 80 and segmented shutter 90.

FIG. 3 shows a block diagram of an embodiment of the receiving apparatus 200. The receiving apparatus comprises a light detector 210 and a processor 220 loaded with a computer program for calculating the orientation (pointing direction) of the pointing device. It may be part of an appliance that is (partially) operated by means of the pointing device.

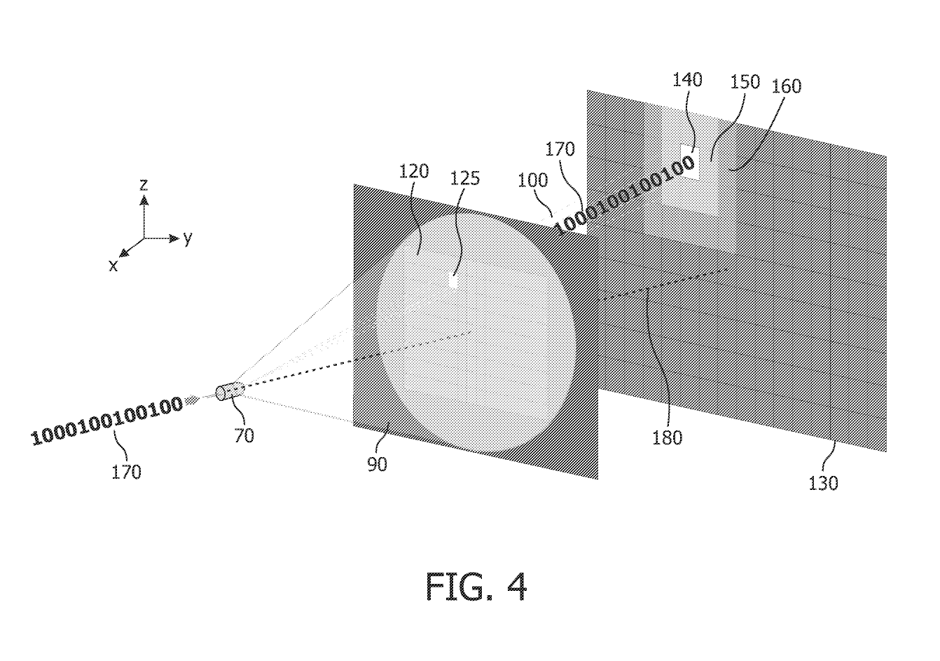

FIG. 4 shows a technical detail drawing of the pointing system. Light source 70 and segment shutter 90 are placed in the housing of the pointing device 10. Segment shutter 90 consists of an array of LCD shutter cells 120. These LCD shutter cells can be turned on and off individually by the controller 110. As a result they either block the light originated from light source 70 or are transparent. If one cell in the segment shutter is not shutting, a single light beam 100 is emitted, creating a light spot 140 on a target surface 130. This target is for instance an appliance to be operated by the pointing device, such as a lighting system, audio device, television set, household appliance, etc. Light spot areas 150 and 160 with lower light intensities are also present around the light spot 140, because of the fact that the light source is not infinitely small.

The cells in the segment shutter are activated cell by cell, one-after the other. Each time a cell is activated, a corresponding light beam in a different direction is emitted. So, a dynamic pattern of light beams, i.e. a pattern of light beams that varies as a function of time, is generated. This will result in a “walking” spot moving along the target surface 130. A data stream 170 is modulated on the generated light. The data stream contains information which cell of the segment shutter is passing light at that moment in time.

In order to keep the “cycle time” i.e. the time that it takes to emit all light beams once reasonably short, the segment shutter preferably has a high switch speed. Available segment shutters fulfilling this requirement are manufactured by the company Bridgestone. These devices have a switch speed of about 200 μs. However, the segment shutter may be implemented by means of any other materials that block or attenuate light or un-focus it and have a high enough switching speed. Examples thereof are shutters manufactured using IMOD (Interferometric Modulator) technology, electrowetting displays or Polymer-dispersed liquid crystals (PDLCs). IMOD pixels are capable of switching speeds in the order of microseconds. These high switching speeds enable the modulation of the data stream 170 on the emitted light beam. Thereto, during the period that corresponds to a certain light beam emission, the corresponding element is switched on and off several times, thereby modulating the light beam with “ones” and “zeros”.

It is now assumed that the pointing device is orientated as shown in FIG. 4, that the light detector 210 of the receiving apparatus 200 is positioned at the location of the light spot 140 and that the cell 125 is not shutting. In this case, the light detector will detect the emitted light beam 100 with the highest signal level. It will also detect the light beams that are emitted when the neighbouring cells of cell 125 are not shutting, although with a lower light intensity. However, it will not detect the light beams emitted by bringing cells that are far away from cell 125 into the transparent mode or only detect these beams with a low intensity, because the resulting light spot will be far away from the location of the light detector. Based on the data stream 170 the processor 220 of the receiving apparatus knows which cell was not shut at the time that it received the highest light intensity. Based on this information and on information about the direction of the resulting light beam when the cell is not shut, which may be loaded to the processor at the time of manufacturing the receiving apparatus or in an initial set-up procedure, the processor has enough information to calculate the orientation of the pointing device relative to the connecting line between the light source 70 and the light detector on the target 140. In this way, the pointing system described thus far is able to determine the position at which the connecting line between source and light detector intersects the segment shutter. In case that it is desirable to translate this position in the source (pointing device) coordinate system unambiguously into a position of the intersection 180 of the pointing axis with the target surface 130 (in the “receiver” coordinate system), the roll angle of the pointing device needs to be determined. The roll angle is defined as the rotation of the pointing device around its longitudinal axis. The roll angle may be determined by applying polarization filters with mutually different angles to different cells of the LCD shutter. For example, two neighbouring cells may comprise different polarization filters, having different polarization angles. In case that the light detector is also equipped with a polarization filter with a polarization angle unequal to the angles of the polarization filters in the LCD shutter, it is possible to determine the roll angle of the pointing device, based on the detected intensities of the light beams generated by shutting off the two cells, as described in detail in the patent applications WO2007/105133 and US 2004/0222969. Alternative solutions are possible, for example groups of three cells may be created with polarization filters having a 60 degrees difference, as described in detail in WO2007/105133.

It is also possible that the receiving apparatus comprises two light detectors each equipped with a different polarization filter. For example, one of the light detectors comprises a vertical polarization filter and the other one a horizontal polarization filter. In this way, the extinguishing of the detected light signal at some roll angles is avoided and weaker light signals emitted by the pointing device from a large distance can be correctly detected.

So, the roll may be taken into account for determining the pointing direction, thereby increasing the accuracy thereof. Alternatively, the roll of the pointing device may be used as a parameter for operating the appliance, in addition to the horizontal and vertical orientation thereof.

While the invention has been illustrated and described in detail in the drawings and foregoing description, such illustration and description are to be considered illustrative or exemplary and not restrictive; the invention is not limited to the disclosed embodiments.

For example, instead of one light detector the receiving apparatus may comprise a plurality of light detectors located at different positions in or near the target. Hereby, the orientation of the pointing device may be determined with a higher accuracy.

Furthermore, instead of activating the cells in the segment cell by cell, one-after the other, a subset (group) of the cells of the segment shutter may be activated at the same time. Hereby, the cycle time, i.e. the time that it takes to activate all cells once, is reduced. The group may consist of cells located far from each other. In this case that it is likely that the light detector only detects the light of one of them, so the accuracy of the final result of the calculation of the pointing device will not be affected. It is also possible that the cells of the group are adjacent. Cells may for example be activated in groups of four adjacent cells (two cells in vertical direction and two in horizontal direction). In this way, a light beam is created that is four times bigger than in the case that the cells are activated one-by-one. This may be done in cases that it is sufficient to determine the orientation of the pointing device with a lower accuracy.

Furthermore, instead of taking only the light beam with the highest detected light intensity into account for determining the orientation of the pointing device, all light beams with a detected light intensity above a certain threshold may be taken into account. An algorithm may be used wherein the contribution of each detected light beam is weighted based on the detected intensity thereof.

Instead of using a segment shutter with cells that completely block light when they are shutting, it is also possible to use cells that attenuate light.

Furthermore, the light emitter may emit a synchronization signal to start a cycle of light emission (i.e. a cycle wherein all light beams are generated once) and subsequently the light emitter varies the subset of the plurality of light beams being emitted as a function of time in a predetermined way. The synchronization signal for example consists of a concurrent emission of all light beams during a short time. The processor of the receiving apparatus determines that the synchronization signal of the pointing device is received. It then determines which of the light beam or light beams are detected based on information regarding the predetermined variations to the subsets of the plurality of light beams being emitted by the pointing device. This information should be stored in the receiving apparatus beforehand or being transmitted from the pointing device to the receiving apparatus by a separate RF or IR link.

Instead of calculating the orientation of the pointing device and based on the determined orientation, providing operating commands to the appliance it is also possible to directly generate commands when certain light beam(s) of the pointing device are detected. For example, if a light beam is detected indicating that the pointing device is pointed upwards, a command for increasing the volume of an audio device or television set may directly be generated, without first calculating the angle of the upwards orientation.

Furthermore, instead of a single light source and a segment shutter, the light emitter may comprise a plurality of laser pointers emitting light beams in mutually different directions. Each light beam may comprise information modulated thereon with the identity of the laser pointer, which is emitting it. The laser pointers may be switched on, one-by-one or in small groups.

Alternatively, the laser pointers all emit light beams with mutually different colours at the same time. This enables the light detector to distinguish the different light beams. Furthermore, the laser pointers may emit light with mutually different polarizations. This enables the receiving apparatus to determine the roll angle of the pointing device. As explained herein above for the embodiment with the segment shutter, groups of two or three laser pointers may be created emitting light with mutually different polarizations.

Instead of determining the roll angle of the pointing device by using polarized light, the roll angle may also be determined by inserting a weight in the pointing device in such a way that the force exercised by the weight on a sensor placed in the pointing device is a function of the roll angle. By measuring the force the roll angle may then be determined.

Alternatively, the pointing device may be a hollow casing wherein the light source and segment shutter are located on a rotatable board in the interior of the hollow casing. By means of one or more suitable weights, the board is always kept in a horizontal position. The roll angle of the pointing device corresponds to the angle between the hollow casing and the board. The pointing device may be enabled to measure this angle by providing the interior surface of the hollow board with bar codes at several angles and providing the circuit board with a bar code detector. The detected bar code is a measure for the roll angle of the pointing device. This information may be modulated on the light that is emitted by the pointing device and in this way be transmitted to the receiving apparatus.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measured cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1. Pointing device comprising
a light emitter for emitting a plurality of individually identifiable light beams in mutually different controlled directions, and
a controller for controlling the light emitter to emit a subset of the plurality of light beams at a time, the subset varying as a function of time, wherein
the light emitter comprises a light source for generating light and a shutter comprising a plurality of segments, wherein the plurality of segments in a first mode are transparent to the light and in a second mode block or attenuate the light, the controller being adapted for controlling the modes of the segments and thereby the emission of the plurality of light beams.

2. (canceled)

3. Pointing device according to claim 2 wherein the controller is adapted for controlling the light emitter to emit the plurality of light beams, sequentially.

4. (canceled)

5. Pointing device according to claim 1 wherein the light emitter comprises a modulator for modulating information on the emitted light indicative of the light beam or light beams being emitted.

6. Pointing device according to claim 1 wherein the controller is adapted to control the light emitter to emit a synchronization signal and to vary the subset of the plurality of light beams being emitted subsequently to the synchronization signal as a function of time and in a predetermined way.

7. Pointing device according to claim 1 wherein the light emitter is adapted for emitting at least some of the plurality of light beams with mutually different light polarizations.

8. Pointing device according to claim 7 wherein the light emitter comprises a plurality of polarization filters with mutually different polarizations for emitting the light beams with mutually different light polarizations.

9. Receiving apparatus comprising:
at least a light detector for detecting one or more of a plurality of individually identifiable light beams emitted by a pointing device, comprising
a light emitter for emitting a plurality of individually identifiable light beams in mutually different controlled directions, and
a controller for controlling the light emitter to emit a subset of the plurality of light beams at a time, the subset varying as a function of time, wherein
the light emitter comprises a light source for generating light and a shutter comprising a plurality of segments, wherein the plurality of segments in a first mode are transparent to the light and in a second mode block or attenuate the light, the controller being adapted for controlling the modes of the segments and thereby the emission of the plurality of light beams, wherein the controller is adapted to control the light emitter to emit a synchronization signal and to vary the subset of the plurality of light beams being emitted subsequently to the synchronization signal as a function of time and in a predetermined way, and
a processor for determining which of the individually identifiable light beam or light beams are detected, the processor being configured
to determine the pointing direction of the pointing device based on the determined one or more light beams and on information about the direction thereof and
to determine that a synchronization signal of the pointing device is received and which of the one or more light beams being detected based at least in part on information about variations to a subset of the plurality of light beams being emitted by the pointing device, subsequently to the synchronization signal.

10. (canceled)

11. Receiving apparatus according to claim 9, further comprising a demodulator for demodulating information modulated on the emitted light, which is indicative of the light beam or light beams emitted by the pointing device, the processor determining which of the light beam or light beams are detected based on the demodulated information.

12. (canceled)

13. Receiving apparatus according to claim 9 wherein the light detector is adapted for detecting the light intensity of the detected light beam or light beams.

14. Receiving apparatus according to claim 9 wherein the light detector comprises a light polarization filter.

15. (canceled)
